(19) United States
(12) Patent Application Publication
(10) Pub. No.: US 2012/0108786 A1
(43) Pub. Date: May 3, 2012

(54) ORGANIC SYSTEM FOR THE RING-OPENING POLYMERIZATION OF CYCLIC CARBONATES IN ORDER TO OBTAIN (BIO)-POLYCARBONATES

(75) Inventors: Christophe Navarro, Lahonce (FR); Didier Bourissou, Plaisance Du Touch (FR); Blanca Martin-Vaca, Toulouse (FR); Damien Delcroix, Castelsarrasin (FR)

(73) Assignees: Arkema France, Colombes (FR); Universite Paul Sabatier Toulouse, Toulouse (FR); Centre National De La Recherche Scientifique, Paris (FR)

(21) Appl. No.: 13/260,998

(22) PCT Filed: Mar. 31, 2010
(86) PCT No.: PCT/FR2010/050608

§ 371 Date: Dec. 12, 2011

(30) Foreign Application Priority Data
Mar. 31, 2009 (FR) 0952057

(51) Int. Cl. C08G 64/02; C08G 64/30; B01J 31/02

(52) U.S. Cl. 528/370; 502/168; 502/167

(57) ABSTRACT

An organocatalytic system, having a sulfonic acid as catalyst, for the polymerization of carbonates, and a polymerization process employing said system to obtain bio-polycarbonates devoid of ether units inserted by decarboxylation. The catalyst system for the ring-opening polymerization reaction of cyclic carbonates is formed of an initiator and, as catalyst, of a sulfonic acid of formula R′—SO₃H, where R′ denotes either:
a linear alkyl group including from 1 to 20 carbon atoms or a branched or cyclic alkyl group including from 3 to 20 carbon atoms, or
a an aryl group.

The present invention relates to the ring-opening polymerization of cyclic carbonates. More specifically, a subject matter of the invention is a novel cationic organic system, having a sulfonic acid as catalyst, for the polymerization of carbonates, and a polymerization process which makes it possible to obtain bio-polycarbonates devoid of ether units inserted by decarboxylation.

Polycarbonates are an important class of biomaterials in the form of homopolymers or of copolymers with other biodegradable polyesters. Biodegradable polymers having a controlled architecture are used to encapsulate or act as vehicle for controlled-release medicaments. Biodegradable implants are enjoying great success, in particular in orthopedics, eliminating the operations which were necessary in the past to remove metal components, such as pins, with risks of further fracturing during their removal. Meniscus screws for repairing the cartilages of the knee can be formulated with the desired stiffness by incorporating trimethylene carbonate in the network. They also occupy a position of choice in the formulation of coatings and plastics in melamine and urethane chemistry.

Anionic and coordination-insertion polymerizations are mainly initiated by metal complexes or alkoxides and the phenomenon of decarboxylation is rare in these polymerizations. However, the presence of metal compounds employed in these polymerization processes can have a harmful effect on the stability and/or the performance of the polymers synthesized. Furthermore, it is well known that metal salts catalyze the decomposition of polycarbonates during the use thereof or are undesirable when these polymers are used in biomedical applications.

It is therefore necessary to carry out a stage of purification of the final reaction medium in order to remove the residual metal traces. This stage of post-polymerization treatment is particularly difficult and can prove to be expensive for an effectiveness which is sometimes debatable.

On the other hand, cationic polymerization catalyses virtually automatically exhibit problems of decarboxylation of the polycarbonates. The phenomenon of decarboxylation is undesirable since it reduces the thermal and UV stability of the material thus obtained.

Alternative processes not involving metal catalysts were then provided. These processes employ acids or alkylating agents which act as catalyst by activating the carbonate functional group. These mechanisms then make it possible to dispense with the use of organometallic complexes in the reaction medium.

Kricheldorf et al. provide for the use of methyl triflate (MeOTf) and triethyloxonium tetrafluoroborate (BF₄−Et₃O⁺) as initiators of the polymerization of trimethylene carbonate (TMC) in chlorinated solvents and nitrobenzene, between 25 and 50° C. (J. Macromol. Sci., Chem., A 26(4), 631-44 (1989)). Transfer reactions do not allow them to exceed a number-average molecular weight (Mₙ) of 6000 g/mol with moreover ether units inserted at a level of 5 to 10%, relative to the carbonate units.

Endo et al. test these same catalytic systems on TMC under various conditions of temperature and solvents, in order to minimize the proportion of ether links (Macromolecules, 30, 737-744 (1997)). However, their proportions remain high, from 6 to 29%, and the polydispersity indices between 1.5 and 3.1 for a maximum Mₙ of 2000 to 13 000 g/mol (measured by gel permeation chromatography or GPC). These authors furthermore provide for the use of milder alkylating agents, such as methyl iodide (Mel) or benzyl bromide (BnBr). Decarboxylation no longer appears but the implementation requires very long reaction times of 18 to 96 h, with high charges of catalysts, from 10 to 20%, and temperatures of greater than 100° C. The polydispersity indices are from 1.5 to 3 for an Mₙ range from 1000 to 3700 g/mol.

A novel catalytic system composed of trifluoroacetic acid as catalyst and of a protic initiator of the alcohol or water type is envisaged in J. Pol. Sci.: Part A, 36, 2463-2471 (1998). Decarboxylation is absent for temperatures of 0 and 50° C., respectively for dichloromethane and toluene, and with long reaction times, of 30 and 24 h respectively. In Macromolecules, 33, 4316-4320 (2000), the catalytic system is formed of ethereal hydrochloric acid and water or butyl alcohol. The absence of decarboxylation is demonstrated for long periods of time of 24 h at 25° C. or else for short periods of time, of 1.5 or 3 h, but at temperatures of −40° C.

These organic systems formed of trifluoroacetic acid or ethereal hydrochloric acid and of alcohol, although not resulting in a decarboxylation, require either very long reaction times (at temperatures of 0° C. or 25° C.) or very low temperatures (−40° C.) for shorter periods of time. In both cases, the working conditions are incompatible with operation of the process on the industrial scale.

It would thus be desirable to have available novel systems and processes which make it possible to prepare polycarbonates without inserted ether units, with a low polydispersity index, according to an economical process involving in particular short reaction times combined with temperatures close to ambient temperature and in the absence of any trace of metal entity.

In point of fact, the Applicant Company has discovered that this need could be met by using specific sulfonic acids as catalyst and water or an alcohol as initiator. With this organocatalytic system, a low charge of catalyst makes possible short reaction times, even without heating. Furthermore, the catalytic system does not bring about any decarboxylation, even at temperatures above ambient temperature.

According to a first aspect, a subject matter of the present invention is a catalytic system for the ring-opening polymerization reaction of cyclic carbonates, said system being formed of an initiator and, as catalyst, of a sulfonic acid of formula R′—SO₃H, where R′ denotes:

a linear alkyl group including from 1 to 20 carbon atoms or a branched or cyclic alkyl group including from 3 to 20 carbon atoms, which groups are optionally substituted by one or more substituents chosen independently from oxo and halo groups, such as, for example, fluorine, chlorine, bromine or iodine, or an aryl group optionally substituted by at least:
one linear alkyl substituent including from 2 to 20 carbon atoms or one branched or cyclic alkyl group including from 3 to 20 carbon atoms, said alkyl substituent being itself optionally substituted by at least one halogenated group chosen from fluorine, chlorine, bromine or iodine or by a nitro group, or
a halogenated group chosen from fluorine, chlorine, bromine or iodine, or
a nitro group, or
a CR₁R₂R₃ group, where R₁ denotes a halogen atom and R₂ and R₃ independently denote a hydrogen atom or a halogen atom.

The initiator comprises at least one hydroxyl functional group and is is in particular water or a primary alcohol, for example chosen from: methanol, ethanol, n-propanol, n-butanol, n-pentanol, n-hexanol, neopentyl alcohol, benzyl alcohol and their mixtures. According to a preferred embodiment of the invention, the initiator results from the family of hydroxylated bioresourced or low-weight natural compounds, among which may be mentioned bioethanol, propanediol, glycerol, propylene glycol, isosorbide, xylitol, mannitol, maltitol, erythritol and, more generally, natural molecules of the family of the monosaccharides, such as fructose, ribose and glucose.

According to another embodiment, the initiator is a mono- or polyhydroxylated oligomer or polymer, in particular chosen from:

(alkoxy)polyalkylene glycols, such as (methoxy)polyethylene glycol (MPEG/PEG), polypropylene glycol (PPG) and polytetramethylene glycol (PTMG);

poly(alkyl)alkylene adipate diols, such as poly(2-methyl-1,3-propylene adipate) diol (PMPA) and poly(1,4-butylene adipate) diol (PBA);

α-hydroxylated or α,ω-dihydroxylated and optionally hydrogenated polydienes, such as α,ω-dihydroxylated polybutadiene or α,ω-dihydroxylated polyisoprene;

mono- or polyhydroxylated polyalkylenes, such as mono- or polyhydroxylated polyisobutylene;

polylactides comprising end hydroxyl functional groups, and

polyhydroxyalkanoates such as poly(3-hydroxybutyrate) and poly(3-hydroxyvalerate).

In another alternative form of the invention, the initiator results from the family of the modified or unmodified polysaccharides, such as starch, chitin, chitosan, dextran or cellulose.

According to another possibility, the initiator is a vinyl cooligomer or copolymer of the family of the acrylic, methacrylic, styrene or diene polymers, which results from copolymerization between acrylic, methacrylic, styrene or diene monomers and functional monomers exhibiting a hydroxyl group, such as hydroxylated acrylic or methacrylic monomers, such as, for example, poly(4-hydroxybutyl acrylate), poly(hydroxyethyl acrylate) and poly(hydroxyethyl methacrylate). This polymerization can be carried out according to a conventional radical process, a controlled radical process or an anionic process.

According to yet another possibility, the initiator is a vinyl copolymer obtained by controlled radical polymerization in which the radical initiator and/or the control agent carry at least one hydroxyl functional group.

The oligomers and polymers used as initiators have a number-average molecular weight ranging from 1000 to 100 000 g/mol, for example from 1000 to 20 000 g/mol, and a polydispersity index ranging from 1 to 3, for example from 1 to 2.6.

The use of such oligomers or polymers makes it possible to obtain linear, star or grafted block copolymers, according to the arrangement of the hydroxyl functional group(s) on the polymeric initiator.

The molar ratio of the cyclic monomer to the polymeric initiator varies from 5 to 500, more preferably from 10 to 200 and better still from 40 to 100 (limits included).

The molar ratio of the cyclic monomer to the sulfonic acid varies from 5 to 500, preferably from 10 to 200 and more preferably from 40 to 100 (limits included).

The molar ratio of the initiator to the sulfonic acid varies from 0.1 to 10, preferably from 1 to 5 (limits included).

According to a second aspect, the invention relates to a process for the preparation of a homogeneous polycarbonate, without ether links as determined by NMR, comprising a stage consisting in reacting a cyclic carbonate of following formula I:

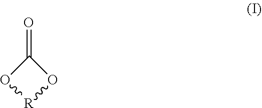

where R denotes a linear alkylene group including from 2 to 20 carbon atoms or a branched alkylene or alkylarylene group including from 2 to 20 carbon atoms, which groups are optionally substituted by one or more substituents chosen independently from oxo and halo groups, such as, for example, fluorine, chlorine, bromine or iodine, in a nonchlorinated aromatic solvent.

This reaction stage requires a time ranging from 10 minutes to 12 h, preferably of between 1 h and 3 h. It takes place at temperatures of between 0 and 110° C., preferably of between 20 and 30° C., limits included.

Another subject matter of the invention is a homogeneous polycarbonate capable of being obtained according to the above process, which will now be described in more detail.

The term “homogeneous polycarbonate” is understood here to mean a polycarbonate devoid of ether connections, which homogeneity is characterized by NMR by virtue of the absence of signals of the CH₂—O—CH₂ type. Its number-average molar mass is greater than 15 000 g/mol with low polydispersity indices, of between 1 and 1.2.

Mention will be made, as nonexhaustive example of cyclic carbonate, of trimethylene carbonate, 2,2-dimethyltrimethylene carbonate and 2-methyl, 2-carboxybenzyl trimethylene carbonate.

According to a preferred embodiment, the cyclic carbonate results entirely from biorenewable resources. By way of example, the trimethylene carbonate will advantageously be prepared by condensation between bioresourced 1,3-propanediol and carbon dioxide. In the context of the invention, the property of a product of being bioresourced is understood within the meaning of the standard ASTM D6852.

The catalytic system according to the invention is particularly advantageous as it makes it possible to polymerize cyclic carbonates with low charges of catalyst and requires short reaction times, even under mild conditions. Furthermore, the polycarbonates formed in the presence of said catalytic system are devoid of ether units inserted by decarboxylation, this being the case even when the polymerization reaction takes place at high temperature, as demonstrated by NMR.

Furthermore, the polycarbonates obtained are devoid of any trace of metal as they were synthesized in the absence of metal catalysts. When they result from renewable resources, polymers of bio-polycarbonate type are obtained. This property, combined with the above, very particularly recommend the polycarbonates according to the invention for use as biomaterials, namely as biodegradable implants, or for encapsulating or acting as vehicle for controlled-release medicaments.

The invention will now be illustrated by means of the following examples, which do not limit the scope of the invention.

### EXAMPLE 1

### Preparation of Trimethylene Carbonate (TMC) Homopolymers

The following general process was used to carry out the processes described below.

The alcohols and the toluene were distilled over sodium. The trimethylene carbonate was dried in solution in dry tetrahydrofuran (THF) over calcium hydride (CaH₂) and recrystallized 3 times from cold THF. The sulfonic acids were used without additional purification. The diisopropylethylamine (DIEA) was dried and distilled over CaH₂ and stored over potassium hydroxide (KOH).

The Schlenk tubes were dried with a heat gun under vacuum in order to remove any trace of moisture.

The reaction was monitored by Bruker ¹H NMR (proton nuclear magnetic resonance) and Waters GPC (gel permeation chromatography) in THF. To do this, samples were withdrawn, neutralized with DIEA, evaporated and taken up in an appropriate solvent for the purpose of their characterization. ¹H NMR makes it possible to quantify the degrees of polymerization of the monomers (DP) by determining the integration ratio of half of the signals of the —CH₂— groups carrying the O—C(═O)O functional group to the signals of the protons of the —CH₂— groups carrying the —OH functional group initially on the initiator. The incorporation of ether units in the polycarbonate can be detected by the signal of the —CH₂— groups carrying the ether functional group —O—. The spectra are recorded in deuterated chloroform on a 300 MHz spectrometer. GPC in THF gives us the number-average molecular weight Mₙ, the weight-average molecular weight M_{w} and the polydispersity index (PDI).

### EXAMPLE 1A

Pentanol (14.7 μl, 1 eq.) and methanesulfonic acid (8.8 μl, 1 eq.) are successively added to a solution of trimethylene carbonate (550 mg, 40 eq., 0.9 mol.1⁻¹) in toluene (6 ml). The reaction medium is stirred under argon at 30° C. until conversion of the monomer, established from NMR, is complete, i.e. 4 h 30.

Conversion of the TMC: ≧99%

¹H NMR: DP=32 with 0% decarboxylation (spectrum shown in the appended FIG. 1)

GPC: Mₙ=6000 g/mol, PDI=1.18.

### EXAMPLE 1 B

Water (2.4 1 eq.) and methanesulfonic acid (8.8 μl, 1 eq.) are successively added to a solution of trimethylene carbonate (550 mg, 40 eq., 0.9 mol.1⁻¹) in toluene (6 ml). The reaction medium is stirred under argon at 30° C. until conversion of the monomer, established from NMR, is complete, i.e. 2 h 30.

Conversion of the TMC: ≧99%

¹H NMR: 0% decarboxylation

GPC: Mₙ=4500 g/mol, PDI=1.08.

### EXAMPLE 1C

Water (2.4 μl, 1 eq.) and methanesulfonic acid (8.8 μl, 1 eq.) are successively added to a solution of trimethylene carbonate (1.1 g, 80 eq., 0.9 mol.1⁻¹) in toluene (12 ml). The reaction medium is stirred under argon at 80° C. until conversion of the monomer, established from NMR, is complete, i.e. 1 h 30. The corresponding NMR spectrum is presented in the appended FIG. 2.

Conversion of the TMC: ≧99%

¹H NMR: 0% decarboxylation

GPC: Mₙ=7500 g/mol, PDI=1.17.

The formation of ether units is detected by a triplet at 3.50 ppm, corresponding to the CH₂ groups in the a position with respect to the oxygen —CH₂—O—CH₂—. The appended spectra show that, at different conversions and until conversion of TMC is complete, no signal is detected at 3.50 ppm by the side of the signal of the terminal CH₂OH.

### EXAMPLE 1D

### Comparison of Initiating With Water and With Pentanol

Initiating with Water

Water (1.8 μl, 1 eq.) and methanesulfonic acid (40 μl, 3 eq.) are successively added to a solution of trimethylene carbonate (825 mg, 80 eq., 0.9 mol.1⁻¹) in toluene (9 ml). The reaction medium is stirred under argon at 30° C. until conversion of the monomer, established from NMR, is complete, i.e. 8 h.

Conversion: ≧99%

¹H NMR: 0% decarboxylation

GPC: Mₙ=9300 g/mol, PDI=1.05, Monomodal profile

GPC Sample Results

| | Retention | | | | |
|---|---|---|---|---|---|
| | Time | Mn | Mw | MP | Polydispersity |
| 1 | 7.971 | 9229 | 9690 | 9822 | 1.05 |

Initiating with Pentanol

Pentanol (11 μl, 1 eq.) and methanesulfonic acid (40 μl, 1 eq.) are successively added to a solution of trimethylene carbonate (825 mg, 80 eq., 0.9 mol.1⁻¹) in toluene (9 ml). The reaction medium is stirred under argon at 30° C. until conversion of the monomer, established from NMR, is complete, i.e. 10 h.

Conversion: ≧99%

NMR: 0% decarboxylation

GPC: Mₙ=8200 g/mol, PDI=1.17, Bimodal profile

GPC Sample Results

| | Retention | | | | |
|---|---|---|---|---|---|
| | Time | Mn | Mw | MP | Polydispersity |
| 1 | 8.083 | 8162 | 9541 | 8135 | 1.17 |

Initiating with Water

Water (1.2 μl, 1 eq.) and methanesulfonic acid (22 μl, 5 eq.) are successively added to a solution of trimethylene carbonate (2.05 g, 300 eq., 0.9 mol.1⁻¹) in toluene (22 ml). The reaction medium is stirred under argon at 80° C. until conversion of the monomer, established from NMR, is complete, i.e. 4 h.

Conversion: ≧99%

¹H NMR: 0% decarboxylation

GPC: Mₙ=14 100 g/mol, PDI=1.12, Monomodal profile

GPC Sample Results

| | Retention | | | | |
|---|---|---|---|---|---|
| | Time | Mn | Mw | MP | Polydispersity |
| 1 | 7.692 | 14 043 | 15 768 | 15 586 | 1.12 |

Initiating with Pentanol

Pentanol (7.3 μl, 1 eq.) and methanesulfonic acid (22 μl, 5 eq.) are successively added to a solution of trimethylene carbonate (2.05 g, 300 eq., 0.9 mol.1⁻¹) in toluene (22 ml). The reaction medium is stirred under argon at 80° C. until conversion of the monomer, established from NMR, is complete, i.e. 8 h.

Conversion: >99%

¹H NMR: 0% decarboxylation

GPC: Mₙ=15 300 g/mol, PDI=1.42, Bimodal profile

GPC Sample Results

| | Retention | | | | |
|---|---|---|---|---|---|
| | Time | Mn | Mw | MP | Polydispersity |
| 1 | 7.423 | 15 295 | 21 685 | 24 029 | 1.42 |

### EXAMPLE 1E

### Synthesis of a TMC Homopolymer With a High Weight Mₙ>20 000

Water (2.4 μL, 1 eq.) and methanesulfonic acid (43 μl, 5 eq.) are successively added to a solution of trimethylene carbonate (1.375 g, 100 eq., 0.9 mol.1⁻¹) in toluene (15 ml). The reaction medium is maintained under argon with vigorous stirring at 30° C. When conversion of the monomer, established from NMR, is complete, i.e. 6 h, 1.375 g (100 eq.) of trimethylene carbonate are added in one go. In the same way, when conversion of the monomer is complete, a third portion of 1.375 g (100 eq.) is added to the reaction medium.

Overall conversion: ≧99%

¹H NMR: 0% decarboxylation

GPC: Mₙ=25 000 g/mol, PDI=1.07, Monomodal profile

GPC Sample Results

| | Retention | | | | |
|---|---|---|---|---|---|
| | Time | Mn | Mw | MP | Polydispersity |
| 1 | 7.336 | 25 388 | 27 082 | 27 553 | 1.07 |

### EXAMPLE 2

### Preparation of Trimethylene Carbonate (TMC) Copolymers

### EXAMPLE 2A

### Preparation of a Poly(dimethylsiloxane)-b-poly(trimethylene carbonate) Diblock Copolymer

α-Hydroxylated poly(dimethylsiloxane) (833 mg, 0.13 mmol) and methanesulfonic acid (8.8 μl, 1 eq.) are successively added to a solution of trimethylene carbonate (137.5 mg, 10 eq., 0.9 mol.1⁻¹) in toluene (1.5 ml). The reaction medium is stirred under argon at 30° C. until conversion of the monomer, established from NMR, is complete, i.e. 1 h.

Conversion of the TMC: ≧99%

¹H NMR: DP(TMC)=9, 0% decarboxylation

GPC: Mₙ=7 400 g/mol, PDI=1.26.

### EXAMPLE 2B

### Preparation of a Poly(trimethylene carbonate-b-poly(dimethylsiloxane)-b-poly(trimethylene carbonate) Triblock Copolymer

α,ω-Dihydroxylated poly(dimethylsiloxane) (833 mg, 0.13 mmol) and methanesulfonic acid (8.8 μl, 1 eq.) are successively added to a solution of trimethylene carbonate (275 mg, 20 eq., 0.9 mol.1⁻¹) in toluene (3 ml). The reaction mixture is stirred under argon at 30° C. until conversion of the monomer, established from NMR, is complete, i.e. 1 h.

Conversion of the TMC: ≧99%

¹H NMR: DP(TMC)=19, 0% decarboxylation

GPC: Mₙ=8500 g/mol, PDI=1.24.

### EXAMPLE 2C

### Preparation of a Poly(lactic acid)-b-poly(trimethylene carbonate) Diblock Copolymer

Poly(lactic acid) (Mₙ=1530 g.mol⁻¹) (206 mg, 0.13 mmol) and methanesulfonic acid (8.8 μl, 1 eq.) are successively added to a solution of trimethylene carbonate (275 mg, 20 eq., 0.9 mol.1⁻¹) in toluene (3 ml). The reaction medium is stirred under argon at 30° C. until conversion of the monomer, established from NMR, is complete, i.e. 1 h.

Conversion of the TMC: ≧99%

¹H NMR: DP(TMC)=9, 0% decarboxylation

GPC: Mₙ=4300 g/mol, PDI=1.14.

### EXAMPLE 2D

### Preparation of a Poly(ε-caprolactone)-b-poly(trimethylene carbonate) Diblock Copolymer

Poly(ε-caprolactone) (166 mg, 0.13 mmol) and methanesulfonic acid (8.8 μl, 1 eq.) are successively added to a solution of trimethylene carbonate (137.5 mg, 10 eq., 0.9 mol.1⁻¹) in toluene (1.5 ml). The reaction medium is stirred under argon at 30° C. until conversion of the monomer, established from NMR, is complete, i.e. 1 h.

Conversion of the TMC: ≧99%

¹H NMR: DP(TMC)=9, 0% decarboxylation

GPC: Mₙ=2700 g/mol, PDI=1.17.

### EXAMPLE 2E

### Preparation of a Poly(trimethylene carbonate)-b-poly(hydrogenated butadiene)-b-poly(trimethylene carbonate) Triblock Copolymer

490 mg of trimethylene carbonate (40 eq., 0.9 mol.1⁻¹) and 11 μl of trifluoromethanesulfonic acid (1 eq.) are successively added to a solution of 360 mg (0.13 mmol) of Krasol® HLBH-P 3000 (α,ω)-dihydroxylated hydrogenated polyolefin of low molecular weight, from Sartomer) (M˜3000 g/mol, Mₙ˜5550 g/mol, PDI=1.08) in 5.3 ml of toluene. The reaction medium is stirred under argon at 30° C. for 2 h (conversion: 100%). The medium is neutralized and evaporated.

NMR: DP(TMC)=39

GPC: Mₙ=9630 g/mol, PDI=1.22.

### EXAMPLE 2

### Preparation of a Poly(trimethylene carbonate)-b-poly(butadiene)-b-poly(trimethylene carbonate) Triblock Copolymer

490 mg of trimethylene carbonate (40 eq., 0.9 mol.1⁻¹) and 11 μl of trifluoromethanesulfonic acid (1 eq.) are successively added to a solution of 350 mg (0.13 mmol) of Krasol® LBH-P 3000 (α,ω-dihydroxylated polyolefin of low molecular weight, from Sartomer) (M˜3000 g/mol, Mₙ˜5600 g/mol, PDI=1.11) in 5.3 ml of toluene. The reaction medium is stirred under argon at 30° C. for 2 h (conversion: 100%). The medium is neutralized and evaporated.

NMR: DP(TMC)=41

GPC: Mₙ=10 200 g/mol, PDI=1.28.

1. A catalyst system for the ring-opening polymerization reaction of cyclic carbonates, said system being formed of an initiator comprising water and, as catalyst, of a sulfonic acid of formula R′—SO₃H, where R′ denotes either:
a linear alkyl group including from 1 to 20 carbon atoms or a branched or cyclic alkyl group including from 3 to 20 carbon atoms, which groups are optionally substituted by one or more substituents chosen independently from oxo and halo groups, or
an aryl group optionally substituted by at least:
one linear alkyl substituent including from 2 to 20 carbon atoms or one branched or cyclic alkyl group including from 3 to 20 carbon atoms, said alkyl substituent being itself optionally substituted by at least one halogenated group selected from the group consisting of fluorine, chlorine, bromine and iodine or by a nitro group, or
a halogenated group selected from the group consisting of fluorine, chlorine, bromine and iodine, or
a nitro group, or
a CR₁R₂R₃ group, where R₁ denotes a halogen atom and R₂ and R₃ independently denote a hydrogen atom or a halogen atom.

2. The system as claimed in claim 1, in which said sulfonic acid is methanesulfonic acid or trifluoromethanesulfonic acid.

3. The system as claimed in claim 1, in which the molar ratio of the cyclic carbonate to the initiator ranges from 5 to 500.

4. The system as claimed in claim 1, in which the molar ratio of the cyclic carbonate to the sulfonic acid varies from 5 to 500.

5. The system as claimed in claim 1, in which the molar ratio of the initiator to the sulfonic acid varies from 0.1 to 10.

6. A process for the preparation of a homogeneous polycarbonate, without ether links, starting from a cyclic carbonate of following formula I: 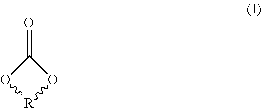
where R denotes a linear alkylene group including from 2 to 20 carbon atoms or a branched alkylene or alkylarylene group including from 2 to 20 carbon atoms, which groups are optionally substituted by one or more substituents chosen independently from oxo and halo groups, comprising a stage of reaction of said cyclic carbonate in a nonchlorinated aromatic solvent, in the presence of a catalyst system as claimed in claim 1.

7. The process as claimed in claim 6, in which the cyclic carbonate is chosen from the group consisting of trimethylene carbonate, 2,2-dimethyltrimethylene carbonate and 2-methyl, 2-carboxybenzyl trimethylene carbonate.

8. The process as claimed in claim 6, in which the cyclic carbonate results from a renewable source.

9. The process as claimed claim 6, in which said reaction stage takes place at temperatures of between 0 and 110° C. for a period of time of between 10 minutes to 12 h.

10. A homogeneous polycarbonate, without ether links and devoid of any trace of metal, capable of being obtained by the process as claimed in claim 6.

11. A composition comprising at least one polycarbonate as claimed in claim 10.

12. The system as claimed in claim 1, in which the molar ratio of the cyclic carbonate to the initiator ranges from 10 to 200.

13. The system as claimed in claim 1, in which the molar ratio of the cyclic carbonate to the initiator ranges from 40 to 100.

14. The system as claimed in claim 1, in which the molar ratio of the cyclic carbonate to the sulfonic acid varies from 10 to 200

15. The system as claimed in claim 1, in which the molar ratio of the cyclic carbonate to the sulfonic acid varies from 40 to 100.

16. The system as claimed in claim 1, in which the molar ratio of the initiator to the sulfonic acid varies from 1 to 5.

17. The process as claimed in claim 6, in which the cyclic carbonate is prepared by condensation between bioresourced 1,3-propanediol and carbon dioxide.

18. The process as claimed in claim 6, in which said reaction stage takes place at temperatures of between 20 and 30° C., for a period of time of between 1 h and 3 h.

19. The system as claimed in claim 1, wherein the halo groups comprise fluorine, chlorine, bromine, or iodine.
